(19) United States
(12) Patent Application Publication
(10) Pub. No.: US 2006/0272595 A1
(43) Pub. Date: Dec. 7, 2006

(54) Handle with bag roll attachable to leash

(76) Inventor: Timothy Edwards, Del Mar, CA (US)

Correspondence Address: KELLY LOWRY & KELLEY, LLP, 6320 CANOGA AVENUE, SUITE 1650, WOODLAND HILLS, CA, 91367, US

(21) Appl. No.: 11/144,958

(22) Filed: Jun. 2, 2005

(51) Int. Cl. A01K 27/00

(52) U.S. Cl. 119/795

(57) ABSTRACT

A leash handle includes a generally hollow grip having an aperture permitting access to an interior cavity thereof. A retaining structure extends forwardly of the grip for securing a leash to the leash handle. A plurality of bags are disposed within the interior cavity of the grip.

### BACKGROUND OF THE INVENTION

The present invention relates in general to leash assemblies and devices for collecting animal litter. More particularly, the present invention relates to a leash handle incorporating bags into the handle.

The rapid increase of urban population coupled with the increasing popularity of dogs and other pets has created a serious sanitary problem in connection with the disposal of animal litter, and particular canine litter. Because many animal pet owners have permitted their animals to deposit solid excrement on both private and public property, a number of communities have enacted ordinances requiring pet owners, under penalty of fine, to retrieve and dispose of lifter created by their pets.

It has been found that the willingness of pet owners to retrieve and properly dispose of animal lifter is related to the ease, convenience and economy with which the litter may be handled in a clean and sanitary manner. While a number of devices have been proposed for the purpose of disposing of animal litter, they have suffered from various shortcomings. Some devices are not completely disposable and, therefore, require some degree of cleanup. Other types of devices, both of the disposable and reusable varieties, are awkward and/or conspicuous to carry. Moreover, some prior animal lifter collection devices are too expensive for everyday use.

One commonly accepted method for collecting and storing animal litter until a proper disposal site can be found involves the use of a disposable plastic bag. Some pet owners will simply place a plastic bag, such as a plastic grocery bag, in a clothing pocket for retrieval when needed. This method of collecting animal lifter presupposes, however, that the pet owner will always have access to and remember to grab a plastic bag prior to walking the pet. There have been proposals to provide devices which would store plastic bags within a container that may be worn by the owner or the pet. Each of these prior devices, however, suffers several disadvantages which the present invention is intended to overcome.

The retractable leash has been gaining popularity for the last twenty years and has taken its place as a permanent pet product. Some have recognized the desirability of providing an easy way to carry pet waste cleanup bags when going for a walk utilizing such a retractable leash. For example, U.S. Pat. No. 5,540,469 discloses a retractable leash placed into an animal waste collecting device which incorporates its own handle, bag holder and flashlight. It is believed, however, that such an assembly involves apparatus and associated costs which are undesirable.

Accordingly, there is a need for a leash handle which provides access to bags when needed. There is a further need for a leash handle which incorporates bags into the handle. There is an additional need for a leash handle that a conventional leash can attach to. The present invention fulfills these needs and provides other related advantages.

### SUMMARY OF THE INVENTION

The present invention provides a leash handle which provides access to bags when needed and further provides a leash handle which incorporates bags into the handle. A conventional leash can be attached to the leash handle.

A leash handle embodying the present invention includes a generally hollow grip having an aperture permitting access to an interior cavity thereof. A retaining structure extends forwardly of the grip for securing a leash to the leash handle. A plurality of bags are disposed within the interior cavity of the grip.

The leash handle includes a leash lock associated with the retaining structure.

The plurality of bags are detachably connected end to end and come in the form of a roll of bags. The bags are individually removable from the grip through the aperture.

The leash handle includes a lid permitting access to the interior cavity. The lid includes an aperture and a flexible membrane having slits substantially aligned with the aperture for the removal of bags from the interior cavity through the lid. The lid comprises a removable cap over the aperture of the grip.

The grip is of unitary construction with at least a portion of the retaining structure.

The retaining structure comprises a carabiner. The retaining structure and grip define a central space; a portion of the leash being held within the central space when attached to the leash handle. The retaining structure includes a recess and means for securing a portion of a leash in the recess.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a front perspective view of a leash handle embodying the present invention with a user's hand wrapped around a grip of the leash handle and a loop handle of a conventional leash being held by the leash handle;

FIG. 2 is a side elevational view of the leash handle of FIG. 1 shown without the user's hand;

FIG. 3 is a downwardly looking rear perspective view of the leash handle of FIG. 2;

FIG. 4 is an upwardly looking rear perspective view of the leash handle of FIG. 2;

FIG. 5 is a downwardly looking rear perspective view of another leash handle embodying the present invention;

FIG. 6 is an upwardly looking rear perspective view of the leash handle of FIG. 5; and

FIG. 7 is a front perspective view of the leash handle of FIG. 5.

### DETAILED DESCRIPTION OF THE PREFERRED EMBODIMENT

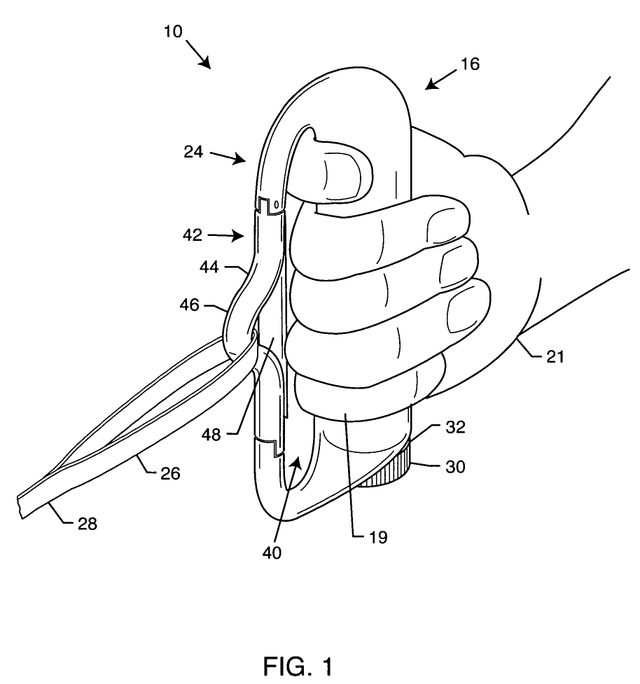

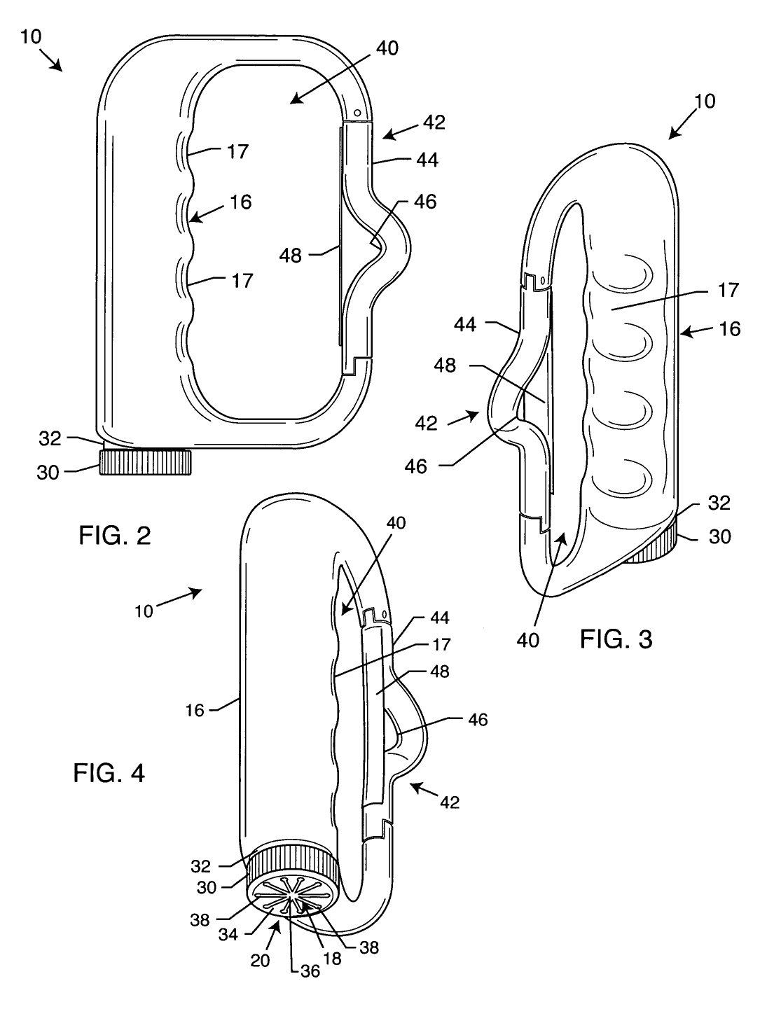

As shown in FIGS. 1-4 for purposes of illustration, the present invention resides in a leash handle 10 having a roll 12 of a plurality of bags 14 located in a generally hollow grip 16 at one end of the leash handle 10. The grip 16 includes indents 17 to aid fingers 19 of a user's hand 21 in wrapping around the grip 16. The grip 16 has an aperture 18 at an open end 20 of the grip 16 that permits access to an interior cavity 22 of the grip 16. A retaining structure 24 extends forwardly of the grip 16 for securing a handle loop 26 of a conventional leash 28 to the leash handle 10. The roll 12 of bags 14 are disposed within the interior cavity 22 of the grip 16. The bags 14 are detachably connected end-to-end.

The leash 28 connects to a collar (not shown), harness (not shown) or the like. The grip 16 is formed with the retaining structure 24 and is of unitary construction with the retaining structure 24. The roll 12 of plastic bags 14 is disposed within the interior cavity 22 of the grip 16 such that the bags 14 may be individually removed therefrom through the aperture 18 of the open end 20 of the grip 16. The roll 12 of plastic bags 14 may be inserted into the interior cavity 22 through the open end 20 of the grip 16.

The leash handle 10 includes a lid 30 which serves as a removable cap for covering over and enclosing the aperture 18 of the open end 20 of the grip 16. The lid 30 also provides access to the interior cavity 22 of the grip 16. The interior surface of the lid 30 is threaded (not shown) so as to engage threads (not shown) of a neck 32 of the grip 16. This allows the lid 30 to be connected to the neck 32 of the grip 16. In the alternative, the lid 30 may be designed to snap-fit onto the open end 20 of the grip 16. In another alternative, a cord (not shown) or the like may be interconnected between the lid 30 and the grip 16 so that the lid 30 does not fall to the ground when the lid 30 is removed to install a replacement roll 12 of bags 14.

In use, fifteen or so plastic bags 14 are wound about an axle (not shown) to form the roll 12. The bags 14 are preferably releasably attached to one another such that one bag 14 may be easily separated from another after being withdrawn from the grip 16, yet the bags 14 are sufficiently attached to one another to prevent such separation as the bags 14 are being withdrawn from the grip 16. The lid 30 may be removed from the grip 16 to place the roll 12 within the interior cavity 22.

The lid 30 includes a flexible membrane 34 which has an aperture 36 therethrough. The membrane 34 includes a number of slits 38, typically in the form of cross-slits, substantially aligned with the aperture 36 for removal of bags 14 from the interior cavity 22 of the grip 16 through the membrane 34. The plastic bags 14 are detachably connected to one another and rolled so that once the first bag 14 is removed through the cross-slits 38, the next bag 14 is partially exposed through the lid 30 for easy removal. The flexible membrane 34 is preferably resilient so that the cross-slits 38 somewhat close upon the partially exposed bag 14 to hold the bag 14 in place. In this manner, the next bag 14 of the roll 12 is always partially exposed through the lid 30 until the roll 12 of bags 14 is exhausted. Once exhausted, a new roll 12 of bags 14 is inserted into the interior cavity 22 of the grip 16.

The retaining structure 24 and grip 16 define a central space 40. A portion of the leash 28 (typically the handle loop 26) is held within the central space 40 when the leash 28 is attached to the leash handle 10. The leash handle 10 includes a leash lock 42 associated with the retaining structure 24. The leash lock 42 of the retaining structure 24 is in the form of a carabiner (i.e., a gated connector: a metal loop with a usually sprung gate designed as a connector that can quickly and reversibly join together components) having a spring-biased member 44 that pivots to allow the handle loop 26 of the leash 26 to be secured about the member 44 within the central space 40. The member 44 includes a recess 46 and a flexible flange 48 connected on one end to the member 44 and disposed over the recess to serve as a means for securing the handle loop 26 in the recess 46. As seen in FIG. 7, a user merely raises the flexible flange 48 enough to allow the thickness of the handle loop 26 to pass between the flange 48 and the member 44 so that the handle loop 22 can be secured in the recess 46. Once the handle loop 26 is in position, the flange 48 moves back into position adjacent the member 44.

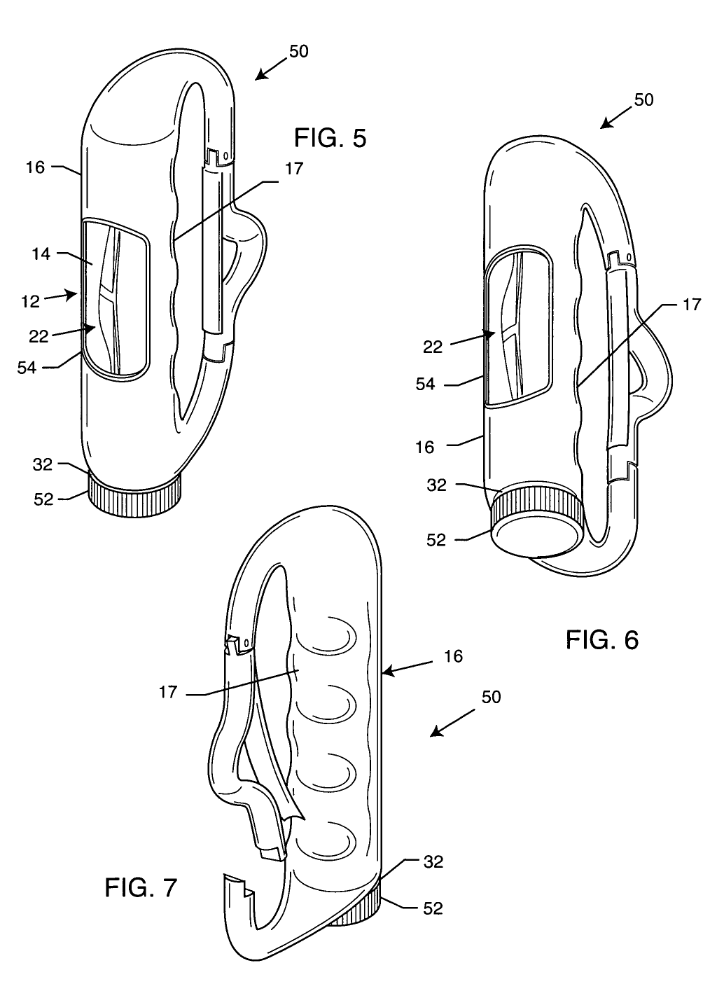

An additional embodiment of the present invention, illustrated in FIGS. 5-7, is in the form of a leash handle 50, similar to the leash handle 10 described above. However, in this embodiment, a lid 52 which provides access to the interior cavity 22 of the grip 16 and serves as a removable cap for covering over and enclosing the aperture 18 of the open end 20 of the grip 16 is different from the lid 30 described above in that bags 14 cannot be removed through the lid 52 itself. Instead, the bags 14 are removed from the interior cavity 22 of the grip 16 through a window aperture 54 on a side of the grip 16. The bags 14 are individually removable from the grip 16 through the aperture 54. The interior surface of the lid 52 is threaded (not shown) so as to engage threads (not shown) of the neck 32 of the grip 16. This allows the lid 52 to be connected to the neck 32 of the grip 16. In the alternative, the lid 52 may be designed to snap-fit onto the open end 20 of the grip 16. In another alternative, a cord (not shown) or the like may be interconnected between the lid 52 and the grip 16 so that the lid 52 does not fall to the ground when the lid 52 is removed to install a replacement roll 12 of bags 14.

In the alternative, the leash handle 10, 50 of the present invention can also be configured to incorporate into or otherwise attach a radio, a walkie talkie or a cell phone into the handle 10, 50. With these configurations a user can listen to music or talk with someone while walking his or her pet. A flashlight can also be incorporated into the leash handle 10, 50, providing light while walking a pet in the dark.

Although two embodiments have been described in detail for purposes of illustration, various modifications may be made without departing from the scope and spirit of the invention.

What is claimed is:

1. A leash handle, comprising:
a generally hollow grip having means for permitting access to an interior cavity thereof;
a retaining structure extending from the grip for securing a leash to the leash handle; and
a plurality of bags disposed within the interior cavity of the grip.

2. The leash handle of claim 1, including a leash lock associated with the retaining structure.

3. The leash handle of claim 1, wherein the plurality of bags are detachably connected.

4. The leash handle of claim 1, wherein the bags comprise a roll of bags.

5. The leash handle of claim 1, including a closure permitting access to the interior cavity.

6. The leash handle of claim 5, wherein the closure includes an aperture for the removal of bags from the interior cavity through the closure.

7. The leash handle of claim 5, wherein the closure comprises a removable cap over the aperture of the grip.

8. The leash handle of claim 1, wherein the bags are individually removable from the grip through the aperture.

9. The leash handle of claim 1, wherein the grip is of unitary construction with at least a portion of the retaining structure.

10. The leash handle of claim 1, wherein the retaining structure comprises a carabiner.

11. The leash handle of claim 1, wherein the retaining structure and grip define a central space; a portion of the leash being held within the central space when attached to the leash handle.

12. The leash handle of claim 1, wherein the retaining structure includes a recess and means for securing a portion of a leash in the recess.

13. A leash handle, comprising:
a generally hollow grip having an aperture permitting access to an interior cavity thereof;
a closure permitting access to the interior cavity;
a retaining structure extending from the grip for securing a leash to the leash handle; and
a plurality of bags disposed within the interior cavity of the grip;
wherein the retaining structure and grip define a central space; a portion of the leash being held within the central space when attached to the leash handle.

14. The leash handle of claim 13, including a leash lock associated with the retaining structure.

15. The leash handle of claim 13, wherein the bags comprise a roll of bags detachably connected.

16. The leash handle of claim 13, wherein the closure comprises a removable cap over the aperture of the grip, the cap including an aperture and a flexible membrane having slits substantially aligned with the aperture for the removal of bags from the interior cavity through the closure.

17. The leash handle of claim 13, wherein the bags are individually removable from the grip through the aperture.

18. The leash handle of claim 13, wherein the retaining structure includes a recess and means for securing a portion of a leash in the recess.

19. A leash handle, comprising:
a generally hollow grip having an aperture permitting access to an interior cavity thereof;
a lid permitting access to the interior cavity;
a retaining structure extending forwardly of the grip and including a recess and means for securing a leash in the recess;
a leash lock associated with the retaining structure; and
a plurality of bags disposed within the interior cavity of the grip, the bags being individually removable from the grip through the aperture;
wherein the retaining structure and grip define a central space; a portion of the leash being held within the central space when attached to the leash handle.

20. The leash handle of claim 19, wherein the lid includes an aperture and a flexible membrane having slits substantially aligned with the aperture for the removal of bags from the interior cavity through the lid.
